(19) United States
(12) Patent Application Publication
(10) Pub. No.: US 2026/0167484 A1
(43) Pub. Date: Jun. 18, 2026

(54) MANUFACTURING METHOD FOR CO-PRODUCTION OF HYDROGEN GAS AND BIOCHAR

(71) Applicant: NATIONAL CHENG KUNG UNIVERSITY, Tainan City (TW)

(72) Inventors: Wei-Hsin CHEN, Kaohsiung City (TW); Chen-Hsiang TENG, Kaohsiung City (TW); Zhi-Xiang WANG, Taipei City (TW)

(21) Appl. No.: 18/981,698

(22) Filed: Dec. 16, 2024

(51) Int. Cl. C01B 3/02

(52) U.S. Cl. CPC C01B 3/02; C01B 2203/06; C01B 2203/107; C01B 2203/1076; C01B 2203/1619; C01B 2203/84

(57) ABSTRACT

A manufacturing method for co-production of hydrogen gas and biochar includes utilizing a hydrogen production system to sequentially perform a hydrogen production step and a heating step on a biomass, wherein the hydrogen production step generates the hydrogen gas and waste heat. The hydrogen production system includes a reactor configured to accommodate a catalyst and the biomass, a gas supply module communicated with the reactor and configured to supply oxygen gas, and a liquid supply module communicated with the reactor and configured to provide methanol liquid and water, wherein the oxygen gas to the methanol liquid (O₂/C) has a specific molar ratio and the water to the methanol liquid (S/C) has a specific molar ratio. The disclosed biochar is produced by recovering the waste heat, which can effectively recover waste heat, improve energy efficiency, and be beneficial to the development of renewable energy technologies and promote a circular bioeconomy.

### BACKGROUND

### Field of Invention

The present disclosure relates to a manufacturing method for co-production of hydrogen gas and biochar.

### Description of Related Art

A large amount of waste biomass is generated every year around the world. Waste biomass can be made into biochar or biofuel. However, biochar is typically produced through a high-temperature pyrolysis reaction, which requires additional energy supply, resulting in high energy consumption.

Hydrogen is an energy source with high energy density, environmental friendliness and versatile applications. Specifically, hydrogen is considered as a clean energy source because its combustion does not pollute the environment. Since hydrogen is widely used in fields such as fuel cells, distributed power generation, refining, and petrochemicals, the development of cost-effective and high-efficient hydrogen production technology is crucial for advancing the hydrogen energy sector. A known method for hydrogen production involves the use of methanol. However, the high-temperature waste heat generated by the methanol hydrogen production is often not fully utilized, resulting in energy waste.

### SUMMARY

The disclosed manufacturing method for co-production of hydrogen gas and biochar utilizes a hydrogen production system to sequentially perform a hydrogen production step and perform a heating step on a biomass. Hydrogen gas and waste heat are generated by controlling a ratio (O₂/C) of oxygen gas to methanol liquid and a ratio (S/C) of water to methanol liquid, and the waste heat is then utilized for the heating step on the biomass to obtain the biochar. The disclosed biochar is produced by recovering the waste heat, which can effectively recover waste heat and improve energy efficiency. Combining hydrogen production with biochar production is beneficial to the development of renewable energy technologies and promotes a circular bioeconomy.

At least one example of the present disclosure provides a manufacturing method for co-production of hydrogen gas and biochar. The method includes utilizing a hydrogen production system to sequentially perform a hydrogen production step and perform a heating step on a biomass, in which the hydrogen production step generates the hydrogen gas and waste heat. The hydrogen production system includes a reactor, a gas supply module, and a liquid supply module. The reactor is configured to accommodate a catalyst and a biomass. The gas supply module is communicated with the reactor and configured to supply oxygen gas. The liquid supply module is communicated with the reactor and configured to supply methanol liquid and water, in which a molar ratio (O₂/C) of the oxygen gas to the methanol liquid is 0.3˜2, and a molar ratio (S/C) of the water to the methanol liquid is not greater than 2.5, in which the waste heat generated in the hydrogen production step is utilized to perform the heating step on the biomass to obtain the biochar.

In at least one example of the present disclosure, the reactor further includes a first quartz wool and a second quartz wool. The first quartz wool is disposed between the catalyst and the biomass. The second quartz wool is disposed below the biomass.

In at least one example of the present disclosure, the manufacturing method for co-production of hydrogen gas and biochar further includes, before performing the hydrogen production step and the heating step, performing a preheating step on the catalyst.

In at least one example of the present disclosure, the catalyst includes a cuprous oxide catalyst, and a preheating temperature in the preheating step is 250° C. to 300° C.

In at least one example of the present disclosure, the catalyst includes a platinum catalyst, and a preheating temperature in the preheating step is 150° C. to 200° C.

In at least one example of the present disclosure, the molar ratio (S/C) of the water to the methanol liquid is 1 to 2.5.

In at least one example of the present disclosure, the molar ratio (O₂/C) of the oxygen gas to the methanol liquid is 0.3 to 0.6, and the molar ratio (S/C) of the water to the methanol liquid is 0.

In at least one example of the present disclosure, a gas hourly space velocity (GHSV) of the hydrogen production system is 5000 h⁻¹ to 10000 h⁻¹.

In at least one example of the present disclosure, the hydrogen production system further includes a first thermocouple thermometer and a second thermocouple thermometer. The first thermocouple thermometer is disposed in the reactor and configured to measure a first temperature in the hydrogen production step. The second thermocouple thermometer is disposed in the reactor and configured to measure a second temperature in the heating step.

In at least one example of the present disclosure, the first temperature is 310° C. to 460° C.

In at least one example of the present disclosure, the first temperature is 400° C. to 620° C.

In at least one example of the present disclosure, a reaction time in the hydrogen production step is 15 minutes to 2 hours.

In at least one example of the present disclosure, a methanol conversion of the hydrogen production system is at least 77%.

In at least one example of the present disclosure, a hydrogen yield of the hydrogen production system is 1 to 2 mol·(mol CH₃OH)⁻¹.

In at least one example of the present disclosure, a heating temperature in the heating step is 110° C. to 350° C., and a heating time in the heating step is 30 minutes to 2 hours.

In at least one example of the present disclosure, a heating temperature in the heating step is 300° C. to 470° C., and a heating time in the heating step is 30 minutes to 2 hours.

In at least one example of the present disclosure, after the heating step is performed for 5 minutes, a gas concentration of oxygen content in the hydrogen production system is less than 1%.

In at least one example of the present disclosure, a contact angle of the biochar is 86° to 103°.

In at least one example of the present disclosure, a higher heating value (HHV) of the biochar is 18 MJ·kg⁻¹ to 23 MJ·kg⁻¹.

In at least one example of the present disclosure, a higher heating value (HHV) of the biochar is 16 MJ·kg⁻¹ to 26 MJ·kg⁻¹.

In at least one example of the present disclosure, a fixed carbon (FC) content of the biochar is 20% to 40%.

In at least one example of the present disclosure, a fixed carbon (FC) content of the biochar is 25% to 50%.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram illustrating a hydrogen production system in accordance with some embodiments of the present disclosure.

FIG. 2 is an enlargement view of the reactor in FIG. 1.

FIG. 3 is a flow chart of a manufacturing method for co-production of hydrogen gas and biochar in accordance with some embodiments of the present disclosure.

FIG. 4A was a temperature graph of the catalyst position for Experimental examples 1 to 5 in aspect 1.

FIG. 4B was a temperature graph of the biochar position for Experimental examples 1 to 5 in aspect 1.

FIG. 5A was a gas concentration graph for Experimental example 1 in aspect 1 without adding SCGs.

FIG. 5B was a gas concentration graph for Experimental example 1 in aspect 1 with adding SCGs.

FIG. 6A was a gas concentration graph for Experimental example 2 in aspect 1 without adding SCGs.

FIG. 6B was a gas concentration graph for Experimental example 2 in aspect 1 with adding SCGs.

FIG. 7A was a gas concentration graph for Experimental example 3 in aspect 1 without adding SCGs.

FIG. 7B was a gas concentration graph for Experimental example 3 in aspect 1 with adding SCGs.

FIG. 8 was a bar chart of HHVs for the non-torrefied SCGs and the torrefied SCGs (Experimental examples 1 to 3) in aspect 1.

FIG. 9 was an image of contact angles for the non-torrefied SCGs and the torrefied SCGs (Experimental examples 1 to 3) in aspect 1.

FIG. 10A was a temperature graph of the catalyst position for Experimental examples 11, 8, 16, 3, and 4 in aspect 2.

FIG. 10B was a temperature graph of the biochar position for Experimental examples 11, 8, 16, 3, and 4 in aspect 2.

FIG. 11A was a gas concentration graph for Experimental example 1 in aspect 2 without adding bamboo.

FIG. 11B was a gas concentration graph for Experimental example 1 in aspect 2 with adding bamboo.

FIG. 12A was a gas concentration graph for Experimental example 3 in aspect 2 without adding bamboo.

FIG. 12B was a gas concentration graph for Experimental example 3 in aspect 2 with adding bamboo.

FIG. 13A was a gas concentration graph for Experimental example 5 in aspect 2 without adding bamboo.

FIG. 13B was a gas concentration graph for Experimental example 5 in aspect 2 with adding bamboo.

FIG. 14 was a bar chart of HHV for the non-pyrolyzed bamboo and the pyrolyzed bamboo (Experimental examples 1 to 5) in aspect 2.

### DETAILED DESCRIPTION

The manufactures and uses of embodiments of the present disclosure are discussed in detail below. However, it is to be understood that the embodiments provide many applicable inventive concepts that can be embodied in a wide variety of specific contexts. The specific embodiments discussed are illustrative only and are not intended to limit the scope of the present disclosure.

In the present disclosure, the range expressed by “one value to another value” is a summary expression that avoids enumerating all the values in the range one by one in the specification. Therefore, the description of a specific range covers any value within that numerical range and a smaller numerical range bounded by any numerical value within that numerical range. It is the same as the arbitrary numerical value and the smaller numerical range is expressly written in the specification.

The terms “about,” “approximately,” “essentially,” or “substantially,” as used herein, include the stated value and the average value within an acceptable range of deviation as determined by one of ordinary skill in the art, considering the specific quantity discussed and the errors associated with the measurement (i.e., limitations of the measurement system). For example, “about” can refer to being within one or more standard deviations of the stated value, or within, for example, ±30%, ±20%, ±15%, ±10%, or ±5%.

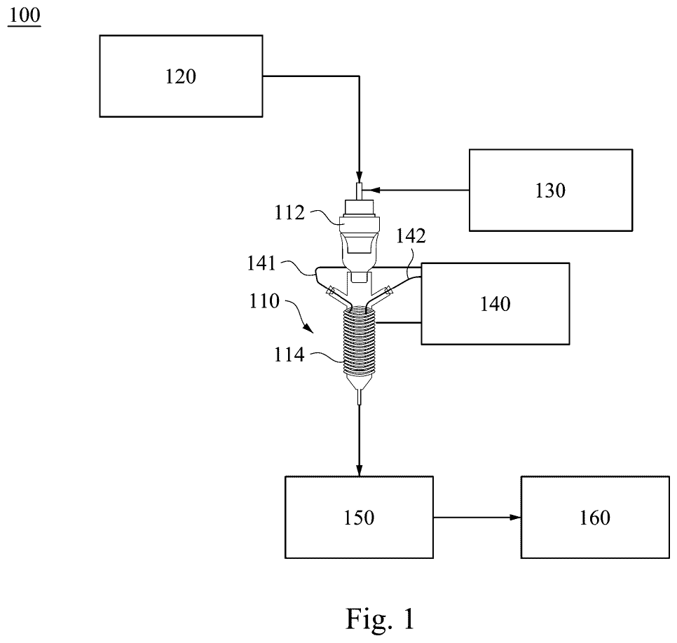

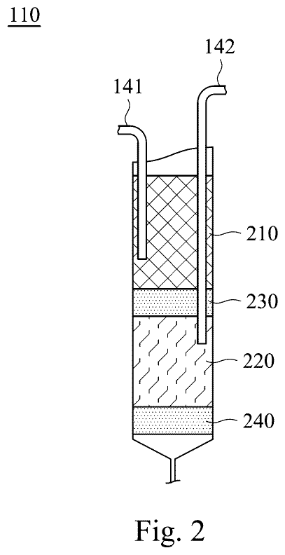

FIG. 1 is a schematic diagram illustrating a hydrogen production system 100 in accordance with some embodiments of the present disclosure. FIG. 2 is an enlargement view of a reactor 110 in FIG. 1. Referring to FIG. 1, the hydrogen production system 100 includes the reactor 110, a gas supply module 120, and a liquid supply module 130. Referring to FIG. 1 and FIG. 2, the reactor 110 is configured to accommodate a catalyst 210 and a biomass 220. As shown in FIG. 1, both the gas supply module 120 and the liquid supply module 130 are communicated with the reactor 110. The gas supply module 120 is configured to supply oxygen gas. The liquid supply module 130 is configured to supply methanol liquid and water. The reactor 110 may be, for example, a quartz tube.

The production of hydrogen using methanol can be achieved through three main methods: methanol steam reforming (MSR), partial oxidation of methanol (POM), and methanol autothermal reforming (ATR). These reactions are represented by the following equations.

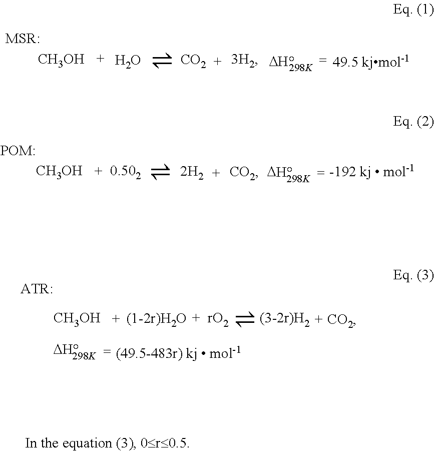

In the MSR reaction, methanol liquid and water are used to produce hydrogen, which is an endothermic reaction. Since the MSR reaction is endothermic, an additional heat source is required, resulting in high energy consumption. In the POM reaction, methanol liquid and oxygen gas are used to produce hydrogen through a catalyst, which is an exothermic reaction. In other words, the reactants of the POM reaction do not contain water. When there is an excess of reactants, the POM reaction can be sustained at the appropriate reaction temperature without the need for additional heating. The ATR reaction combines the MSR reaction with the POM reaction, utilizing the heat released by the POM reaction to provide the heat required for the MSR reaction to sustain the ATR reaction.

Generally speaking, the heat generated by the ATR reaction is usually considered as waste heat because it is unnecessary for the experiment. In addition, the gases generated during the ATR reaction have low oxygen contents, creating a suitable environment for torrefying or pyrolyzing biomass. The present disclosure combines the waste heat and the low-oxygen gas to integrate hydrogen production and biomass torrefaction or biomass pyrolysis into a co-production system (i.e., the hydrogen production system 100 in FIG. 1). The present disclosure provides a method for waste management and renewable energy production, promoting the development of sustainable energy by achieving the effective reuse of waste heat.

As shown in FIG. 1, the reactor 110 further includes an ultrasonic spray device 112. The ultrasonic spray device 112 may form liquid into tiny droplets and produce uniformly fine mist to improve the hydrogen production efficiency. The gas supply module 120 in FIG. 1 may include an air cylinder, a nitrogen cylinder, a gas flow controller, and a gas mixer. The air cylinder is used to supply oxygen gas. The nitrogen cylinder is used to adjust the total gas flow entering the reactor 110. Nitrogen gas does not participate in the chemical reactions in the reactor 110. The nitrogen gas introduced into the reactor 110 may dilute the reaction gases and control a molar ratio (O₂/C) of the oxygen gas to the methanol liquid and a molar ratio (S/C) of the water to the methanol liquid entering the reactor 110. Nitrogen gas may avoid overheating or incomplete combustion caused by excessive reactant concentrations, and may delay the catalyst carbon deposition and extend the lifespan of the catalyst. In addition, introducing an appropriate amount of nitrogen gas into the reactor 110 could control the temperature during the reaction process, so that the nitrogen may stabilize the thermal distribution of the reaction system and avoid local overheating, thereby protecting the catalyst and the equipment. The liquid supply module 130 in FIG. 1 may include a liquid flow controller for controlling the feed of the mixture of methanol liquid and water.

Still referring to FIG. 1, the hydrogen production system 100 further includes a temperature control module 140. The temperature control module 140 is connected to a first thermocouple 141 and a second thermocouple 142, and may display temperatures of the first thermocouple 141 and the second thermocouple 142.

Still referring to FIG. 1, the hydrogen production system 100 further includes a filter module 150. The filter module 150 is communicated with the reactor 110. The filter module 150 may include a filtering device, a condensation device, and a drying device. The filtering device uses gravity to filter out most of the tar, and then gases move to a container filled with filter cotton to remove tiny particles and residual tar. After passing through the condensation device, only gases remain in the products.

Still referring to FIG. 1, the hydrogen production system 100 further includes a gas analysis module 160. The gas analysis module 160 is communicated with the filter module 150 and configured to analyze products. The gas analysis module 160 may include a gas chromatography (GC), a gas analyzer (GA), and a soap bubble flow meter. The gas chromatography is used to analyze the hydrogen concentration. The gas analyzer is used to analyze the concentrations of oxygen gas, carbon dioxide, carbon monoxide, and methane. The soap bubble flow meter is used to analyze gas flows.

As shown in FIG. 1, the reactor 110 further includes a heating tape 114. The heating tape 114 is wrapped around the reactor 110 and connected to the temperature control module 140. The heating tape 114 is configured to preheat the catalyst (such as the catalyst 210 shown in FIG. 2). The preheating temperature of the catalyst is a catalyst temperature before the reaction starts, influencing the activation energy of the catalyst at the beginning of the reaction, which promotes the reaction kinetics and improves the hydrogen production efficiency. The preheating temperature of the catalyst may vary depending on the types of catalysts. In some examples, when the catalyst 210 is a cuprous oxide catalyst, the preheating temperature of the catalyst may be 250° C. to 300° C., such as 260° C., 270° C., 280° C., or 290° C. In some examples, when the catalyst 210 is a platinum catalyst, the preheating temperature of the catalyst may be 150° C. to 200° C., such as 160° C., 170° C., 180° C., or 190° C. It could be understood that FIG. 1 illustrates the heating tape 114, however, in other examples, the preheating catalyst may not be required, and thus the heating tape 114 does not need to be provided.

Referring to FIG. 2, the reactor 110 includes a catalyst 210 (also referred to as a “catalyst bed”), a first quartz wool 230, the biomass 220, and a second quartz wool 240 from top to bottom. In other words, the first quartz wool 230 is disposed between the catalyst 210 and the biomass 220, and the second quartz wool 240 is disposed under the biomass 220. It could be understood that second quartz wool 240 is placed at the bottommost part of the reactor 110 to prevent the upper biomass 220 from falling off the bottom of the reactor 110.

The catalyst 210 may be, for example, the cuprous oxide catalyst or the platinum catalyst, but is not limited thereto. The biomass 220 may include cellulose, hemicellulose, lignin, or combinations thereof. Specifically, the biomass 220 may include, for examples, general agricultural waste (such as rice or rice straw), forestry waste (such as sawdust, bark, or bamboo), food industry waste (such as pericarp), animal manure (such as cow dung or chicken manure), or general waste (such as spent coffee grounds (SCGs)). The weights of the catalyst 210 and the biomass 220 depend on the capacity of the reactor 110.

Referring to FIG. 1 and FIG. 2, the first thermocouple thermometer 141 is disposed in the reactor 110 and configured to measure the temperature around the catalyst 210. The second thermocouple thermometer 142 is disposed in the reactor 110 and configured to measure the temperature around the biomass 220.

The disclosed manufacturing method for co-production of hydrogen gas and biochar includes two aspects, in which aspect 1 is the ATR reaction (the main reactants are methanol liquid, water, and oxygen gas), and aspect 2 is the POM reaction (the main reactants are methanol liquid and oxygen gas). The disclosed manufacturing method for co-production of hydrogen gas and biochar first utilizes the ATR reaction or the POM reaction to generate low-oxygen hydrogen-rich gases and waste heat (high-temperature gases), and then utilizes the waste heat to heat the biomass to obtain the biochar. Therefore, the catalyst 210 and the biomass 220 need to be arranged as shown in FIG. 2 (i.e., the catalyst 210 is above the biomass 220). If the catalyst 210 was below the biomass 220, the production of hydrogen would be seriously affected and the waste heat would not be effectively utilized.

Referring to FIG. 2, the present disclosure utilizes the high-temperature gases of the hydrogen production reaction (i.e., ATR reaction or POM reaction) to heat the biomass 220 below, therefore, the hydrogen production reaction above would not be affected when the biomass 220 below is heated. As a result, the present disclosure could effectively recover waste heat and improve energy efficiency.

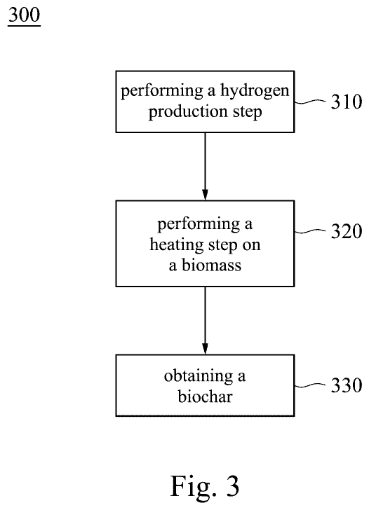

FIG. 3 is a flow chart of a manufacturing method 300 for co-production of hydrogen gas and biochar in accordance with some embodiments of the present disclosure. It could be understood that whether it is the ATR reaction in aspect 1 or the POM reaction in aspect 2, both reactions use the manufacturing method 300 to obtain the biochar.

Referring to FIG. 2 and FIG. 3, in some examples, the manufacturing method 300 includes, before performing a hydrogen production step (i.e., a step 310) and performing a heating step (i.e., a step 320) on the biomass, performing a preheating step on the catalyst 210.

Referring to FIG. 1 and FIG. 3, the hydrogen production step is performed by using the hydrogen production system 100, as shown in the step 310. In the hydrogen production step, hydrogen gas and waste heat are generated. It could be understood that since the hydrogen production step is an exothermic reaction, waste heat will be generated. The main thermochemical reaction in the hydrogen production step is at least one of the above equations (1) to (3), in which when the ATR reaction is performed, the main reactants are methanol liquid, water, and oxygen gas; and when the POM reaction is performed, the main reactants are methanol liquid and oxygen gas. In some examples, a molar ratio (O₂/C) of the oxygen gas to the methanol liquid is 0.3 to 2, such as 0.4, 0.5, 0.6, 0.7, 0.8, 0.9, 1, 1.2, 1.4, 1.6, or 1.8. In some examples, a molar ratio (S/C) of the water to the methanol liquid is not greater than 2.5, such as 0, 0.2, 0.4, 0.6, 0.8, 1, 1.1, 1.2, 1.3, 1.4, 1.5, 1.6, 1.7, 1.8, 1.9, 2, 2.1, or 2.2.

In some examples of the ATR reaction, the O₂/C ratio is 0.3˜2 and the S/C ratio is 1˜2.5. The O₂/C ratio affects the exothermic extent of the POM reaction within the ATR reaction. If the O₂/C ratio<0.3, the exothermic reaction would be incomplete, so the hydrogen generation temperature could not be maintained, which would be disadvantageous for the subsequent heating step of the biomass. Although the hydrogen generation temperature could be maintained by providing additional heat to the reaction system from the outside, the advantage of waste heat recovery of the present disclosure would be lost. If the O₂/C ratio>2 (it means that the oxygen content was too high), the thermochemical reaction may change from partial oxidation to complete oxidation. Complete oxidation would increase hydrogen production byproducts (i.e., carbon dioxide and/or water), thereby reducing the hydrogen yield. If the O₂/C ratio>2, the reaction may be incomplete and may have residual oxygen content, resulting in too high oxygen concentration in the gases after the reaction, which would be disadvantageous for the subsequent biomass torrefaction. The S/C ratio affects the endothermic extent of the MSR reaction within the ATR reaction. If the S/C ratio was greater than 2.5 (it means that the water in the reactants was too much), the above equations (1) to (3) would absorb too much heat, thereby reducing the amount of waste heat in the ATR reaction, which would be disadvantageous for the heating step of the biomass. Part of the hydrogen gas in the ATR reaction is obtained from the water in the reactant, therefore, if the S/C ratio<1, the amount of hydrogen gas would be reduced.

In some examples of the ATR reaction, a reaction time in the hydrogen production step is 15 minutes to 2 hours, such as 30 minutes, 40 minutes, 1 hour, or 1.5 hours. When the reaction time is 15 minutes to 2 hours, the methanol conversion and the hydrogen yield can be improved.

In some examples of the ATR reaction, a temperature of the hydrogen gas generated in the hydrogen production step (the step 310 in FIG. 3) is 310° C. to 460° C. In other words, referring to FIG. 2, the temperature measured by the first thermocouple thermometer 141 is 310° C. to 460° C.

In some examples of the POM reaction, the O₂/C ratio is 0.3˜0.6 and the S/C ratio is 0. It could be understood that since the reactants of the POM reaction does not contain water, the S/C ratio is 0. The O₂/C ratio affects the exothermic extent of the POM reaction. If the O₂/C ratio<0.3, the exothermic reaction would be incomplete, so the hydrogen generation temperature could not be maintained, which would be disadvantageous for the subsequent heating step of the biomass. If the O₂/C ratio>0.6, the POM reaction was a purely exothermic reaction, the resulting reaction temperature may be too high, and partial oxidation may be transformed into complete oxidation, resulting in an increase in by-products, which would be disadvantageous for the subsequent biomass torrefaction. If the O₂/C ratio>0.6, the oxygen content in the reaction gases may be too high, causing the biomass to undergo a combustion reaction instead of a pyrolysis reaction.

In some examples of the POM reaction, a gas hourly space velocity (GHSV) of the hydrogen production system 100 (referring to FIG. 1) is 5000 h⁻¹ to 10000 h⁻¹, such as 6000 h⁻¹, 7000 h⁻¹, 8000 h⁻¹, or 9000 h⁻¹. GHSV is a ratio of the gas flow to the catalyst bed volume under the standard state, representing the residence time of the gases on the catalyst bed (i.e., the catalyst 210 in FIG. 2). The greater the GHSV is, the shorter the residence time of the gases on the catalyst bed is, which leads to incomplete chemical reaction. On the contrary, the less the GHSV is, the longer the residence time of the gases on the catalyst bed is, which increases the reaction conversion rate, but is not suitable for large-scale processes. Therefore, when the GHSV is 5000 h⁻¹ to 10000 h⁻¹, the methanol conversion and the hydrogen yield can be improved.

In some examples of the POM reaction, the reaction time in the hydrogen production step is 15 minutes to 2 hours, such as 20 minutes, 30 minutes, 40 minutes, 1 hour, or 1.5 hours. When the reaction time is 15 minutes to 2 hours the methanol conversion and the hydrogen yield can be improved.

In some examples of the POM reaction, the temperature of the hydrogen gas generated in the hydrogen production step (the step 310 in FIG. 3) is 400° C. to 620° C. In other words, referring to FIG. 2, the temperature measured by the first thermocouple thermometer 141 is 400° C. to 620° C.

In some examples, a methanol conversion of the hydrogen production system 100 (referring to FIG. 1) is at least 77%. The disclosed methanol conversion is calculated using the following equation (4). The methanol conversion is a ratio of the methanol liquid fed into the reaction to other carbon-containing products during the reaction process.

$$methanol conversion ( \% ) = ( \frac{{\dot{n}}_{{CO}_{2} , out} + {\dot{n}}_{CO , out} + {\dot{n}}_{{CH}_{4} , out}}{{\dot{n}}_{C {H}_{3} OH , i n}} ) \times 100. \qquad Eq . ( 4 )$$

In the equation (4), n represents a molar flow rate with unit of

$$\frac{mole}{min} .$$

Specifically, \dot{n}_{CH}_{₃}_{OH,in} represents the molar flow rate of the feed methanol liquid (reactant), and \dot{n}_{CO}_{₂}_{,out}, \dot{n}_{CO,out}, \dot{n}_{CH}_{₄}_{,out} represent the molar flow rates of the outlet carbon dioxide, carbon monoxide, and methane (products), respectively.

In some examples of the ATR reaction, the methanol conversion is 77% to 100%. In some examples of the POM reaction, the methanol conversion is 85% to 100%.

In some examples, the hydrogen yield (H₂ yield) of the hydrogen production system 100 (referring to FIG. 1) is 1 to 2 mol·(mol CH₃OH)⁻¹. The disclosed hydrogen yield is calculated using the following equation (5).

$$hydrogen yield = \frac{{\dot{n}}_{{H}_{2}}}{{\dot{n}}_{{CH}_{3} OH , i n}} . \qquad Eq . ( 5 )$$

In the equation (5), \dot{n} represents a molar flow rate with unit of

$$\frac{mole}{min} .$$

Specifically, \dot{n}_{CH}_{₃}_{OH,in} represents the molar flow rate of the feed methanol liquid (reactant), and \dot{n}_{H}_{₂} represents the molar flow rate of the hydrogen gas (product).

In some examples of the ATR reaction, the hydrogen yield is 1 to 2 mol·(mol CH₃OH)⁻¹. In some examples of the POM reaction, the hydrogen yield is 1.1 to 1.6 mol·(mol CH₃OH)⁻¹.

Referring to FIG. 3, after the hydrogen production step (i.e., the step 310), utilizing the waste generated in the heat hydrogen production step to perform the heating step on the biomass to obtain the biochar, as shown in the step 320 and the step 330.

In some examples of the ATR reaction, a heating temperature in the heating step is 110° C. to 350° C., and a heating time in the heating step is 30 minutes to 2 hours. In other words, referring to FIG. 2, the temperature measured by the second thermocouple thermometer 142 is 110° C. to 350° C. Since the biomass is heated in an oxygen-free environment, the volatile component(s) in the biomass can be effectively reduced, remaining solid products that can be combusted, and increasing a fixed carbon (FC) content in the biomass. Therefore, this heating step can also referred to as a torrefaction step or a pyrolysis step. When the heating temperature and the heating time are within the above ranges, it is beneficial to increase the carbon content and higher heating value (HHV) of the biochar.

In some examples of the POM reaction, the heating temperature in the heating step is 300° C. to 470° C., and the heating time in the heating step is 30 minutes to 2 hours. In other words, referring to FIG. 2, the temperature measured by the second thermocouple thermometer 142 is 300° C. to 470° C. Since the biomass is heated at a relatively high temperature, this heating step can also referred to as a pyrolysis step. When the heating temperature and heating time are within the above ranges, it is beneficial to increase the carbon content and HHV of the biochar.

In some examples, after the above heating step is performed for 5 minutes, a gas concentration of oxygen content in the hydrogen production system 100 (referring to FIG. 1) is less than 1%. When the gas concentration of oxygen content in the hydrogen production system 100 is less than 1%, representing the biomass undergoes the heating step in a low-oxygen environment. In some examples of the ATR reaction, the gas concentration of oxygen content under stable reaction is 0%. In some examples of the POM reaction, the gas concentration of oxygen content under stable reaction is less than 1%.

In some examples of the ATR reaction, a contact angle of the biochar produced by the above manufacturing method 300 is 86° to 103°. The disclosed contact angle is calculated using the following equation (6).

$$θ = 2 {tan}^{- 1} \frac{H}{R} . \qquad Eq . ( 6 )$$

In the equation (6), θ represents the contact angle with unit of degree (°); H represents a height of the biochar with unit of mm; R represents a half-width of the contact surface with the biochar, with unit of mm. The larger the contact angle of the biochar, the more conducive it is to preserve the biochar, reducing the likelihood of mold formation.

HHV is a measure of biomass quality, representing the maximum energy that can be provided during fuel combustion and determining the optimal energy recovery potential of the biomass. In some examples of the ATR reaction, the higher heating value (HHV) of the biochar produced by the above manufacturing method 300 is 18 MJ·kg⁻¹ to 23 MJ·kg⁻¹, and the fixed carbon content of the biochar is 20% to 40%. In some examples of the POM reaction, the higher heating value (HHV) of the biochar produced by the above manufacturing method 300 is 16 MJ·kg⁻¹ to 26 MJ·kg⁻¹, and the fixed carbon content of the biochar is 25% to 50%.

The experimental results of several Experimental examples in aspect 1 (the ATR reaction) and aspect 2 (the POM reaction) are used to describe the applications of the present disclosure, but they are not intended to limit the present disclosure.

### Aspect 1: Experimental Example 1

The catalyst used in aspect 1 was the cuprous oxide catalyst (Cu₂O/Al₂O₃). The detailed specifications of the catalyst refer to the following Table 1.

TABLE 1

| | | | | Total pore | Average |
|---|---|---|---|---|---|
| | Vₘ | | a_{s, BET} | volume | pore |
| | (cm³ (STP) | | (m² · | (cm³ · | diameter |
| Catalyst | g⁻¹) | C | g⁻¹) | g⁻¹) | (nm) |
| Cu₂O/ | 47.861 | 98.598 | 208 | 0.2821 | 5.4166 |
| Al₂O₃ | | | | | |

“Vₘ” represents a monolayer gas adsorption volume (monolayer capacity).
“C” represents an adsorption constant of the catalyst.
“a_{s,BET}” represents a specific surface area of the catalyst.

The biomass in aspect 1 was spent coffee grounds (SCGs). The SCGs was sourced from a convenience store. First, the SCG raw material was filtered to remove impurities, resulting in powered particles. Next, a granulator was used to compress the SCG raw material into cylindrical pellets, each with a diameter of 1.5 cm and a length of 6 cm. Then, the SCGs were dried in a 105° C. oven for 24 hours to reduce the moisture content.

50 grams of the cuprous oxide catalyst and 1.5 grams of the SCGs were placed in the reactor 110 shown in FIG. 2. First, the hydrogen production system 100 shown in FIG. 1 was utilized to perform the preheating step on the cuprous oxide catalyst, in which the preheating temperature is 250° C. Then, the hydrogen production step was performed, in which the O₂/C ratio was 0.8 and the S/C ratio was is 1.5. In the hydrogen production step, the hydrogen gas and the waste heat were generated, in which the reaction time in the hydrogen production step was 1 hour. Next, the waste heat generated in the hydrogen production step was used to perform the heating step on the SCGs to obtain torrefied SCGs (i.e., the biochar), in which the heating time in the heating step was 1 hour. The specific process parameters and the results of Experimental example 1 in aspect 1 were shown in Tables 2 to 4 below.

### Aspect 1: Experimental Examples 2 to 5

Experimental examples 2 to 5 in aspect 1 were performed like Experimental example 1 in aspect 1. The differences were that the O₂/C ratio, the S/C ratio, the preheating temperature of the catalyst, the air flow, and the nitrogen flow in Experimental examples 2 to 5 were changed. The specific process parameters and the results of Experimental examples 2 to 5 were shown in Tables 2 to 4 below.

TABLE 2

| Experimental | Catalyst | SCGs | | | Preheating | Air | Nitrogen |
|---|---|---|---|---|---|---|---|
| examples in | weight | weight | O₂/C | S/C | temperature | flow | flow |
| aspect 1 | [g] | [g] | ratio | ratio | [° C.] | [mL·min⁻¹] | [mL·min⁻¹] |
| Experimental | 50 | 1.5 | 0.8 | 1.5 | 250 | 632 | 868 |
| example 1 | | | | | | | |
| Experimental | 50 | 1.5 | 1.0 | 1.5 | 250 | 791 | 709 |
| example 2 | | | | | | | |
| Experimental | 50 | 1.5 | 1.0 | 1.0 | 300 | 731 | 769 |
| example 3 | | | | | | | |
| Experimental | 50 | 1.5 | 2 | 1 | 300 | 1825 | 0 |
| example 4 | | | | | | | |
| Experimental | 50 | 1.5 | 2 | 2.5 | 300 | 1248 | 251 |
| example 5 | | | | | | | |

TABLE 3

| | | Hydrogen | | | |
|---|---|---|---|---|---|
| | Methanol | gas | CO₂ | CO | Methane |
| Experimental | liquid | output | output | output | output |
| examples in | input | conc. | conc. | conc. | conc. |
| aspect 1 | [mL/min] | [Vol %] | [Vol %] | [Vol %] | [Vol %] |
| Experimental | 1 | 21.4 | 10.8 | 0.21 | 0.15 |
| example 1 | | | | | |
| Experimental | 1 | 17.2 | 12.6 | 0.08 | 0.36 |
| example 2 | | | | | |
| Experimental | 1 | 15.7 | 12.1 | 0.35 | 0.28 |
| example 3 | | | | | |
| Experimental | 1 | 15.2 | 12.4 | 0.42 | 0.13 |
| example 4 | | | | | |
| Experimental | 1 | 20.1 | 10.8 | 0.13 | 0.24 |
| example 5 | | | | | |

TABLE 4

| | | | | Hydrogen |
|---|---|---|---|---|
| Experimental | Hydrogen gas | SCGs | Methanol | yield |
| examples in | temperature | temperature | conversion | [mol · (mol |
| aspect 1 | [° C.] | [° C.] | [%] | CH₃OH)⁻¹] |
| Experimental | 317 | 115 | 84.4 | 1.98 |
| example 1 | | | | |
| Experimental | 375 | 156 | 99.52 | 1.72 |
| example 2 | | | | |
| Experimental | 452 | 176 | 76.98 | 1.69 |
| example 3 | | | | |
| Experimental | 420 | 342 | 85.82 | 1.011 |
| example 4 | | | | |
| Experimental | 358 | 260 | 77.73 | 1.404 |
| example 5 | | | | |

In Table 4, the methanol conversions were calculated using the above equation (4), and the hydrogen yields were calculated using the above equation (5). The results showed that the methanol conversions were 77.73% to 99.52%, and the hydrogen yields were 1.01 to 1.98 mol·(mol CH₃OH)⁻¹.

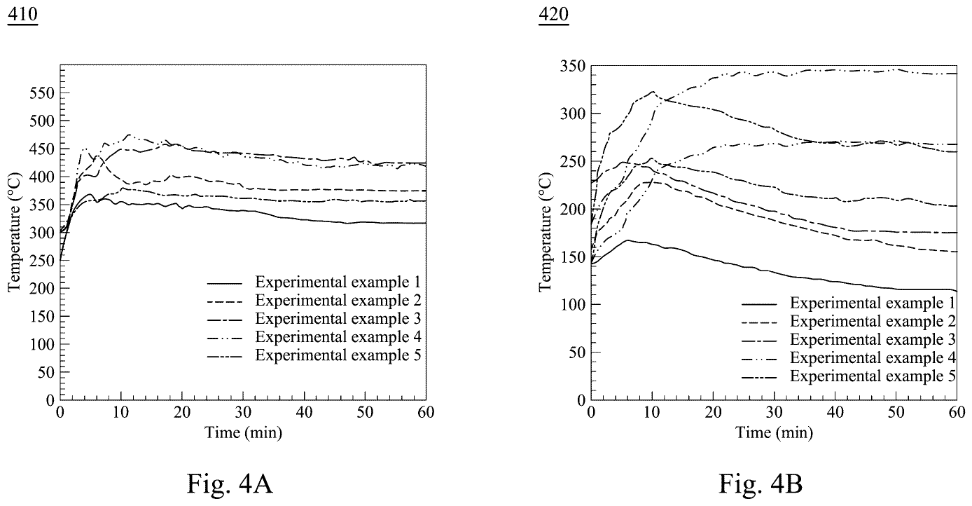

FIG. 4A was a temperature graph 410 of the catalyst position (i.e., the hydrogen gas temperature) for Experimental examples 1 to 5 in aspect 1. As shown in FIG. 4A, after about 5 minutes of the reaction, the hydrogen gas temperature in the hydrogen production step was 31000 to 46000. It could be understood that the catalyst was been preheated to 250° C. or 300° C., so the initial temperature of FIG. 4A was 250° C. or 300° C.

FIG. 4B was a temperature graph 420 of the biochar position for Experimental examples 1 to 5 in aspect 1. As shown in FIG. 4B, the heating temperature in the heating step was 110° C. to 350° C. Because the SCGs were heated in an oxygen-free environment at a relatively low temperature, the heating step also could be referred to as a torrefaction step.

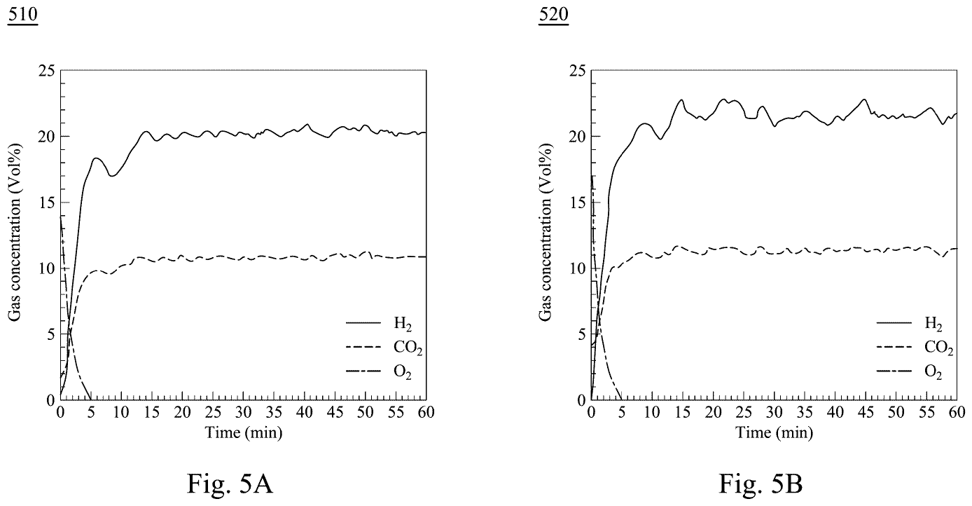

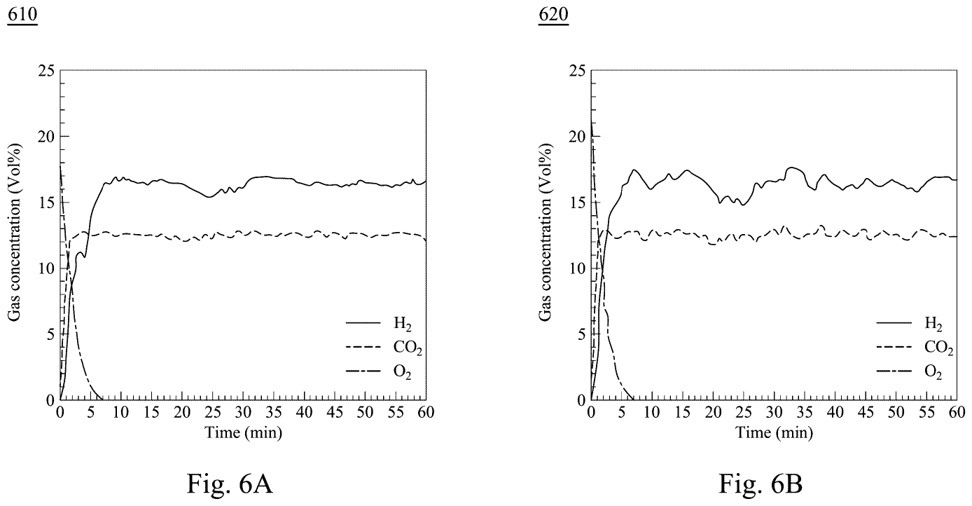

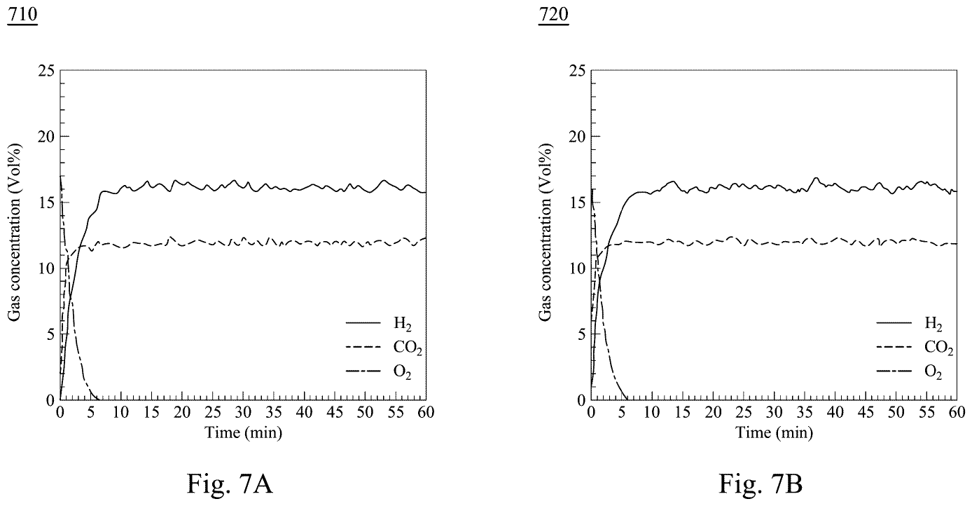

FIG. 5A was a gas concentration graph 510 for Experimental example 1 in aspect 1 without adding SCGs. FIG. 5B was a gas concentration graph 520 for Experimental example 1 in aspect 1 with adding SCGs. FIG. 6A was a gas concentration graph 610 for Experimental example 2 in aspect 1 without adding SCGs. FIG. 6B was a gas concentration graph 620 for Experimental example 2 in aspect 1 with adding SCGs. FIG. 7A was a gas concentration graph 710 for Experimental example 3 in aspect 1 without adding SCGs. FIG. 7B was a gas concentration graph 720 for Experimental example 3 in aspect 1 with adding SCGs. It could be understood that, referring to FIG. 2, the “without adding SCGs” herein means that there was no biomass 220 (SCGs) under the catalyst 210.

As shown in FIG. 5A, FIG. 6A, and FIG. 7A, all the gas concentrations of oxygen content under stable reaction (after about 5 minutes of the reaction) were about 0%, which was suitable as an environment for biomass torrefaction. As shown in FIG. 5A to FIG. 7B, the gas concentrations in Experimental examples for “without adding SCGs” and “with adding SCGs” had similar trends. It could be known that the hydrogen production reaction above would not be affected during the heating of the SCGs below. Therefore, the present disclosure could effectively recover waste heat and improve energy efficiency. As shown in FIG. 5B, FIG. 6B, and FIG. 7B, representing the SCGs underwent the heating (torrefaction) step in the low-oxygen environment.

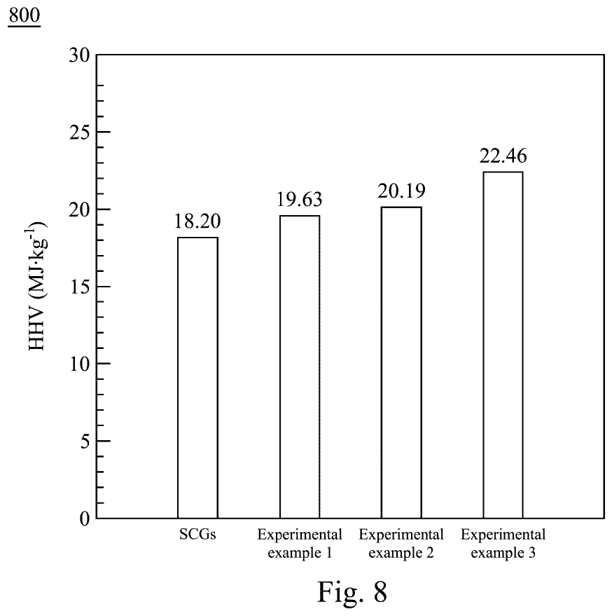

FIG. 8 was a bar chart 800 of HHVs for the non-torrefied SCGs and the torrefied SCGs (Experimental examples 1 to 3) in aspect 1. HHVs of the samples in the present disclosure were measured using a bomb calorimeter. The results showed that HHVs of the SCGs in aspect 1 were 18.2 MJ·kg⁻¹ to 22.46 MJ·kg⁻¹. Compared to the non-torrefied SCGs (HHV was 18.2 MJ·kg⁻¹), HHV of Experimental example 3 in aspect 1 increased by 23.35%. In Experimental examples 1 to 3 in aspect 1, the torrefaction extent of Experimental example 1 is the lowest, and the torrefaction extent of Experimental example 3 was the highest.

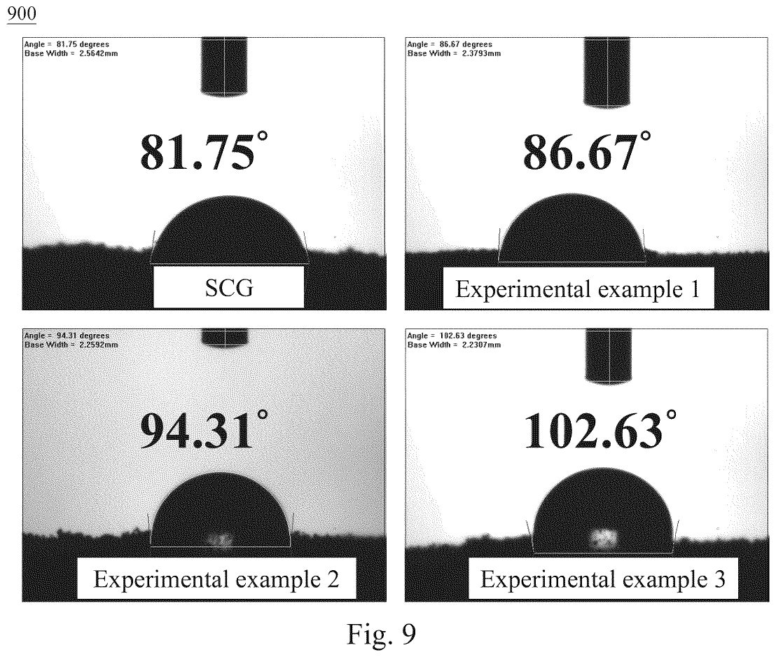

FIG. 9 was an image 900 of contact angles for the non-torrefied SCGs and the torrefied SCGs (Experimental examples 1 to 3) in aspect 1. The contact angle for the non-torrefied SCGs was 81.75°. The contact angles for Experimental examples 1 to 3 were 86.67°, 94.31°, and 102.63°. The contact angles for Experimental example 2 and Experimental example 3 were both greater than 90°, and had hydrophobic properties. The larger the contact angle of the biochar, the more conducive it is to preserve the biochar, reducing the likelihood of mold formation.

Referring to Table 5 below, proximate analysis and elemental analysis (EA) were performed on the non-torrefied SCGs and the torrefied SCGs (Experimental examples 1 to 5). The results showed that, based on carbon (C), hydrogen (H), nitrogen (N), and oxygen (O) in the SCGs as 100 weight percent, the carbon content increased from 45.91% (the non-torrefied SCGs) to 55.26% (Experimental example 4). The increased carbon contents in the SCGs of aspect 1 were beneficial for the subsequent applications biofuels.

TABLE 5

| | | | | | |
|---|---|---|---|---|---|
| Non-torrefied | Experimental | Experimental | Experimental | Experimental | Experimental |
| SCGs | example 1 | example 2 | example 3 | example 4 | example 5 |

Proximate analysis (dry basis) [wt. %]

| | | | | | | |
|---|---|---|---|---|---|---|
| Volatile | 83.44 | 71.82 | 67.12 | 58.61 | 57.43 | 58.23 |
| matter | | | | | | |
| (VM) | | | | | | |
| Fixed | 14.72 | 24.00 | 27.17 | 37.23 | 39.49 | 38.98 |
| Carbon | | | | | | |
| (FC) | | | | | | |
| Ash | 1.84 | 4.18 | 5.71 | 4.16 | 3.07 | 2.79 |

Elemental analysis (dry basis) [wt. %]

| | | | | | | |
|---|---|---|---|---|---|---|
| C | 45.91 | 46.9 | 49.39 | 54.55 | 55.26 | 52.03 |
| H | 6.25 | 6.27 | 6.39 | 6.31 | 5.62 | 5.57 |
| N | 2.01 | 2.03 | 2.18 | 2.42 | 3.33 | 3.05 |
| O | 45.83 | 44.80 | 42.05 | 36.72 | 35.79 | 39.35 |
| (by | | | | | | |
| difference) | | | | | | |
| H/C | 1.62 | 1.59 | 1.54 | 1.38 | 1.22 | 1.28 |
| atomic | | | | | | |
| ratio | | | | | | |
| O/C | 0.75 | 0.72 | 0.64 | 0.51 | 0.48 | 0.56 |
| atomic | | | | | | |
| ratio | | | | | | |

It could be known from the results in Table 5 that the fixed carbon contents of the torrefied SCGs (Experimental examples 1 to 5) were 24% to 39.49%. Compared to the non-torrefied SCGs, the torrefied SCGs (Experimental examples 1 to 5) had lower volatile matter (VM) contents, higher fixed carbon (FC) contents, lower H/C atomic ratios, and lower O/C atomic ratios. Therefore, the torrefied SCGs in aspect 1 were beneficial for the subsequent applications biofuels.

### Aspect 2: Experimental Example 1

The catalyst used in aspect 2 was the platinum catalyst(Pt/Al₂O₃). The detailed specifications of the catalyst refer to the following Table 6.

TABLE 6

| | | | | Total pore | Average |
|---|---|---|---|---|---|
| | Vₘ | | a_{s, BET} | volume | pore |
| | (cm³ (STP) | | (m² · | (cm³ · | diameter |
| Catalyst | g⁻¹) | C | g⁻¹) | g⁻¹) | (nm) |
| Pt/Al₂O₃ | 34.183 | 216.58 | 149 | 0.3591 | 9.6557 |

“Vₘ” represents a monolayer gas adsorption volume (monolayer capacity).
“C” represents an adsorption constant of the catalyst.
“a_{s,BET}” represents a specific surface area of the catalyst.

The biomass in aspect 2 was bamboo. The bamboo raw material was sourced from Taiwan Sugar Corporation. A diameter of the bamboo raw material was about 25 mm to 30 mm, and a thickness of the bamboo raw material was about 5 mm. First, the bamboo raw material was cut into pieces with the size of 10 mm×10 mm×5 mm. Then, the bamboo was dried in a 105° C. oven for 24 hours to reduce the moisture content.

50 grams of the platinum catalyst and 10 grams of the bamboo were placed in the reactor 110 shown in FIG. 2. First, the hydrogen production system 100 shown in FIG. 1 was utilized to perform the preheating step on the platinum catalyst, in which the preheating temperature was 180° C. Then, the hydrogen production step was performed, in which the O₂/C ratio was 0.5, the S/C was 0, and the GHSV was 5000 h⁻¹. In the hydrogen production step, the hydrogen gas and the waste heat were generated, in which the reaction time in the hydrogen production step was 1 hour. Next, the waste heat generated in the hydrogen production step was used to perform the heating step on the bamboo to obtain the pyrolyzed bamboo (i.e., the biochar), in which the heating time in the heating step was 1 hour. The specific process parameters and the results of Experimental example 1 in aspect 1 were shown in Tables 7 to 9 below.

### Aspect 2: Experimental Examples 2 to 5

Experimental examples 2 to 5 in aspect 2 were performed like Experimental example 1 in aspect 2. The differences were that the O₂/C ratio, the catalyst weight, the preheating temperature of the catalyst, GHSV, the air flow, the nitrogen flow, and the methanol liquid flow in Experimental examples 2 to 5 were changed. The specific process parameters and the results of Experimental examples 2 to 5 were shown in Tables 7 to 9.

TABLE 7

| Experimental | Catalyst | Bamboo | | Preheating | | | Nitrogen | Methanol |
|---|---|---|---|---|---|---|---|---|
| examples in | weight | weight | O₂/C | temperature | GHSV | Air flow | flow | liquid flow |
| aspect 2 | [g] | [g] | ratio | [° C.] | [h⁻¹] | [mL·min⁻¹] | [mL·min⁻¹] | [mL·min⁻¹] |
| Experimental | 50 | 10 | 0.5 | 180 | 5000 | 1194 | 1167 | 0.75 |
| example 1 | | | | | | | | |
| Experimental | 40 | 10 | 0.6 | 170 | 9000 | 1433 | 1967 | 0.75 |
| example 2 | | | | | | | | |
| Experimental | 43 | 10 | 0.6 | 200 | 5000 | 1911 | 120 | 1.25 |
| example 3 | | | | | | | | |
| Experimental | 47 | 10 | 0.5 | 150 | 9000 | 1592 | 2403 | 1 |
| example 4 | | | | | | | | |
| Experimental | 50 | 10 | 0.6 | 150 | 10000 | 2388 | 2334 | 1.25 |
| example 5 | | | | | | | | |

TABLE 8

| | Methanol | Hydrogen | CO₂ | CO | Methane | Oxygen content |
|---|---|---|---|---|---|---|
| Experimental | liquid | gas output | output | output | output | gas conc. under |
| examples in | input | conc. | conc. | conc. | conc. | stable reaction |
| aspect 2 | [mL/min] | [Vol %] | [Vol %] | [Vol %] | [Vol %] | [Vol %] |
| Experimental | 0.75 | 21.3 | 6.64 | 7.34 | 1.08 | 0.89 |
| example 1 | | | | | | |
| Experimental | 0.75 | 18.4 | 6.28 | 5.06 | 0.89 | 0.89 |
| example 2 | | | | | | |
| Experimental | 1.25 | 27.5 | 12.57 | 8.45 | 1.38 | 0.83 |
| example 3 | | | | | | |
| Experimental | 1 | 20 | 5.72 | 6.67 | 1.01 | 0.8 |
| example 4 | | | | | | |
| Experimental | 1.25 | 19.6 | 7.46 | 5.75 | 0.82 | 0.78 |
| example 5 | | | | | | |

TABLE 9

| | | | | Hydrogen |
|---|---|---|---|---|
| Experimental | Hydrogen gas | Bamboo | Methanol | yield |
| examples in | temperature | temperature | conversion | [mol · (mol |
| aspect 2 | [° C.] | [° C.] | [%] | CH₃OH)⁻¹] |
| Experimental | 467 | 347 | 85.96 | 1.223 |
| example 1 | | | | |
| Experimental | 510 | 380 | 100 | 1.586 |
| example 2 | | | | |
| Experimental | 517 | 387 | 92.08 | 1.136 |
| example 3 | | | | |
| Experimental | 536 | 395 | 98.77 | 1.483 |
| example 4 | | | | |
| Experimental | 620 | 467 | 95.31 | 1.339 |
| example 5 | | | | |

In Table 8, all the gas concentrations of oxygen content in Experimental examples 2 to 5 under stable reaction were less than 1%. The methanol conversions in Table 9 were calculated using the above equation (4), and the hydrogen yields were calculated using the above equation (5). The results showed that methanol conversions were 85% to 100%, and the hydrogen yields were 1.1 to 1.6 mol·(mol CH₃OH)⁻¹.

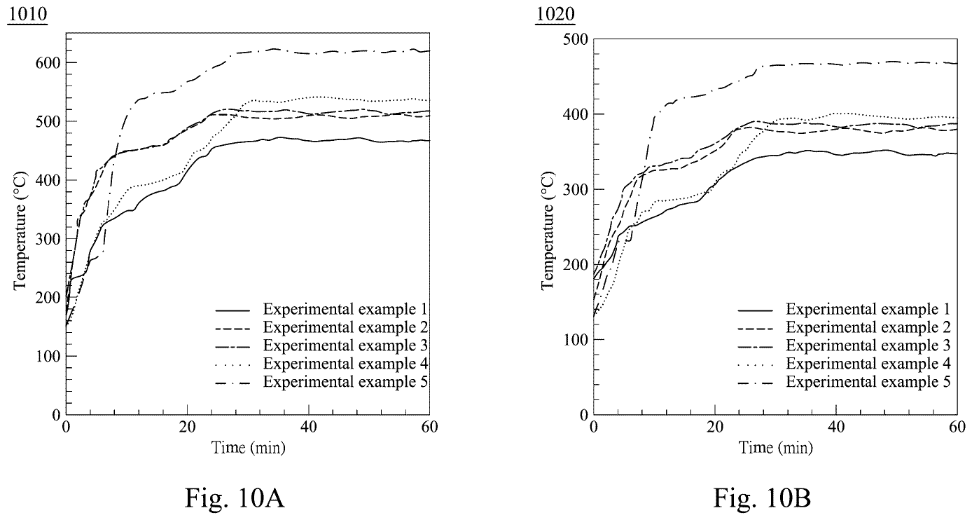

FIG. 10A was a temperature graph 1010 of the catalyst position (i.e., the hydrogen gas temperature) for Experimental examples 1 to 5 in aspect 2. As shown in FIG. 10A, after about 20 minutes of the reaction, the hydrogen gas temperature in the hydrogen production step was 400° C. to 620° C. It could be understood that the catalyst was been preheated to 150° C., 170° C., 180° C., or 200° C., so the initial temperature of FIG. 10A was 150° C., 170° C., 180° C., or 200° C.

FIG. 10B was a temperature graph 1020 of the biochar position for Experimental examples 1 to 5 in aspect 2. As shown in FIG. 10B, after about 20 minutes of the reaction, the heating temperature in the heating step was 300° C. to 470° C. Because the bamboo was heated in an oxygen-free environment at a relatively low temperature, the heating step also could be referred to as a pyrolysis step.

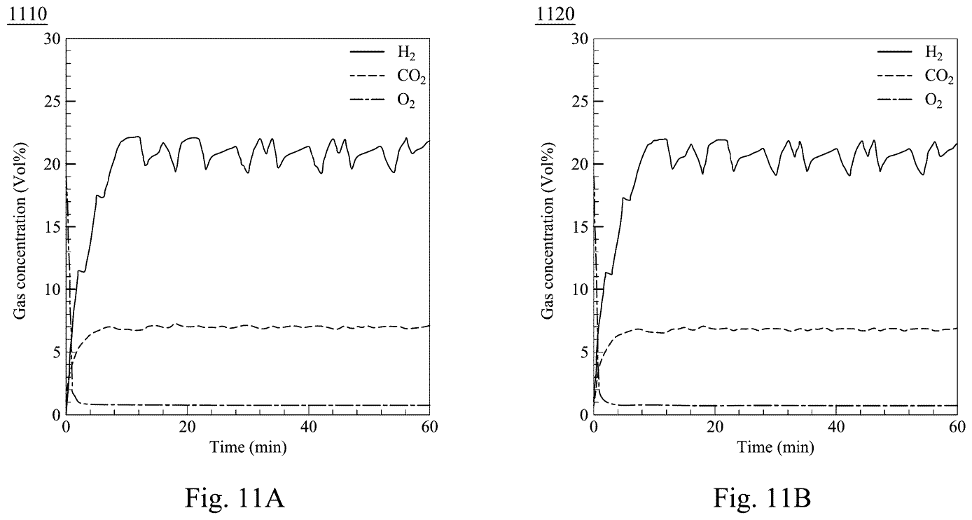

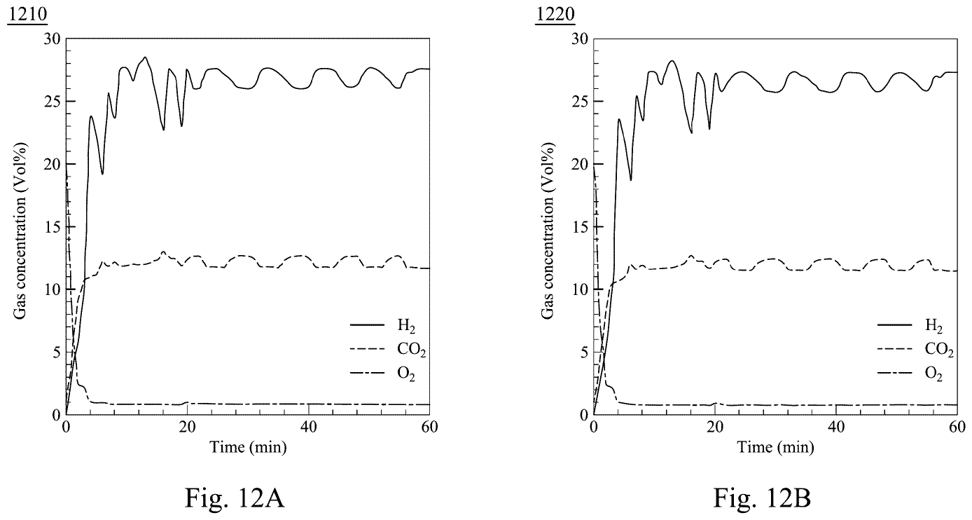

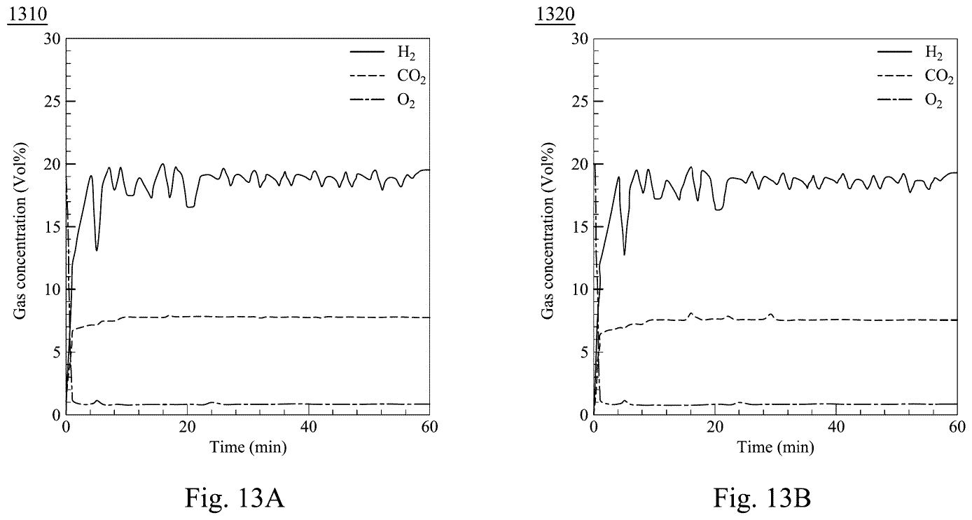

FIG. 11A was a gas concentration graph 1110 for Experimental example 1 in aspect 2 without adding bamboo. FIG. 11B was a gas concentration graph 1120 for Experimental example 1 in aspect 2 without adding bamboo. FIG. 12A was a gas concentration graph 1210 for Experimental example 3 in aspect 2 without adding bamboo. FIG. 12B was a gas concentration graph 1220 for Experimental example 3 in aspect 2 with adding bamboo. FIG. 13A was a gas concentration graph 1310 for Experimental example 5 in aspect 2 without adding bamboo. FIG. 13B was a gas concentration graph 1320 for Experimental example 5 in aspect 2 with adding bamboo. It could be understood that, referring to FIG. 2, the “without adding bamboo” herein means there was no biomass 220 (bamboo) under the catalyst 210.

As shown in FIG. 11A, FIG. 12A, and FIG. 13A, all the gas concentrations of oxygen content under stable reaction (after about 5 minutes of the reaction) were less than 1%, which was suitable as an environment for biomass torrefaction. As shown in FIG. 11A to FIG. 13B, the gas concentrations in Experimental examples for “without adding bamboo” and “with adding bamboo” had similar trends. It could be known that the hydrogen production reaction above would not be affected during the heating of the bamboo below. Therefore, the present disclosure could effectively recover waste heat and improve energy efficiency. As shown in FIG. 11B, FIG. 12B, and FIG. 13B, representing the bamboo underwent the heating (pyrolysis) step in the low-oxygen environment.

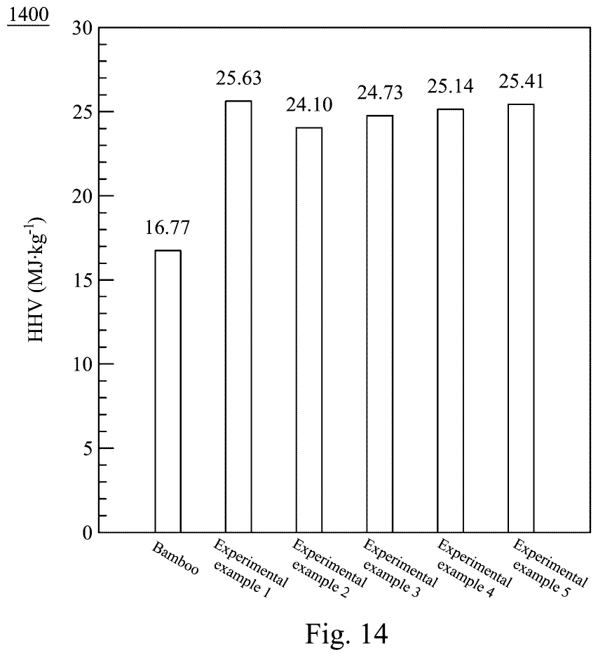

FIG. 14 was a bar chart 1400 of HHVs for the non-pyrolyzed bamboo and the pyrolyzed bamboo (Experimental examples 1 to 5) in aspect 2. The results showed that HHVs of the bamboo in aspect 2 were 16.77 MJ·kg⁻¹ to 25.63 MJ·kg⁻¹. Compared to the non-pyrolyzed bamboo (HHV was 16.77 MJ·kg⁻¹), HHV of Experimental example 1 in aspect 2 was increased by 52.83%.

Referring to Table 10 below, elemental analysis (EA) was performed on the non-pyrolyzed bamboo and the pyrolyzed bamboo (Experimental examples 1 to 5). The results showed that based on carbon (C), hydrogen (H), nitrogen (N), and oxygen (O) in the bamboo as 100 weight percent, the carbon content increased from 44.25 wt. % (the non-pyrolyzedbamboo) to more than 65 wt. % (Experimental examples 1 to 5). The increased carbon contents in the bamboo of aspect 2 were beneficial for the subsequent applications biofuels.

TABLE 10

| | | | | | |
|---|---|---|---|---|---|
| Non-pyrolyzed | Experimental | Experimental | Experimental | Experimental | Experimental |
| bamboo | example 1 | example 2 | example 3 | example 4 | example 5 |

Proximate analysis [wt. %]

| | | | | | | |
|---|---|---|---|---|---|---|
| Volatile | 83.11 | 37.67 | 38.13 | 43.27 | 43.72 | 51.32 |
| matter | | | | | | |
| (VM) | | | | | | |
| Fixed | 6.12 | 47.23 | 46.85 | 38.15 | 36.60 | 28.58 |
| Carbon | | | | | | |
| (FC) | | | | | | |
| Ash | 3.8 | 8.26 | 8.63 | 12.36 | 13.79 | 14.72 |
| Moisture | 6.97 | 6.84 | 6.40 | 6.22 | 5.88 | 5.37 |
| content | | | | | | |

Elemental analysis [wt. %]

| | | | | | | |
|---|---|---|---|---|---|---|
| C | 44.25 | 66.82 | 65.82 | 67.90 | 66.73 | 68.78 |
| H | 5.56 | 4.25 | 4.35 | 4.24 | 3.75 | 3.53 |
| N | 1.22 | 1.36 | 1.21 | 1.37 | 1.27 | 1.33 |
| O | 48.98 | 27.58 | 28.62 | 26.50 | 28.26 | 26.38 |
| (by | | | | | | |
| difference) | | | | | | |
| H/C | 1.51 | 0.76 | 0.79 | 0.75 | 0.67 | 0.62 |
| atomic | | | | | | |
| ratio | | | | | | |
| O/C | 0.83 | 0.31 | 0.33 | 0.29 | 0.32 | 0.29 |
| atomic | | | | | | |
| ratio | | | | | | |

It could be known from the results in Table 10 that the fixed carbon contents of the pyrolyzed bamboo (Experimental examples 1 to 5) were 28.58% to 47.23%. Compared to the non-pyrolyzed bamboo, the pyrolyzed bamboo (Experimental examples 1 to 5) had lower volatile matter (VM) contents, higher fixed carbon (FC) contents, lower H/C atomic ratios, and lower O/C atomic ratios. Therefore, the pyrolyed bamboo in aspect 2 were beneficial for the subsequent applications biofuels.

In summary, the disclosed manufacturing method for co-production of hydrogen gas and biochar utilizes the hydrogen production system to sequentially perform the hydrogen production step and the heating step. Hydrogen gas and waste heat are produced by controlling the ratio (O₂/C) of oxygen gas to methanol liquid and the ratio (S/C) of water to methanol liquid, and the waste heat is then utilized for the heating step on the biomass to obtain the biochar. The disclosed biochar is produced by recovering the waste heat, which can effectively recover waste heat and improve energy efficiency. Combining hydrogen production with biochar production is beneficial to the development of renewable energy technologies and promotes a circular bioeconomy.

It could be understood that while the present disclosure illustrates the manufacturing method for co-production of hydrogen gas and biochar includes by utilizing specific biomass, specific manufacturing methods, and specific evaluation approaches as examples, anyone skilled in the art would recognize that the present disclosure is not limited to these examples. Other types of biomass, alternative manufacturing methods, or different evaluation approaches may also be employed without departing from the spirit and scope of the present disclosure. Therefore, the scope of protection of the present disclosure shall be subject to the scope of the claims attached in the application.

What is claimed is:

1. A manufacturing method for co-production of hydrogen gas and biochar, comprising:
utilizing a hydrogen production system to sequentially perform a hydrogen production step and perform a heating step on a biomass, wherein the hydrogen production step generates the hydrogen gas and waste heat, and the hydrogen production system comprises:
a reactor configured to accommodate a catalyst and the biomass;
a gas supply module communicated with the reactor and configured to supply oxygen gas; and
a liquid supply module communicated with the reactor and configured to supply methanol liquid and water, wherein a molar ratio (O₂/C) of the oxygen gas to the methanol liquid is 0.3 to 2, and a molar ratio (S/C) of the water to the methanol liquid is not greater than 2.5, wherein the waste heat generated in the hydrogen production step is utilized to perform the heating step on the biomass to obtain the biochar.

2. The manufacturing method for co-production of hydrogen gas and biochar of claim 1, wherein the reactor further comprises:
a first quartz wool disposed between the catalyst and the biomass; and
a second quartz wool disposed below the biomass.

3. The manufacturing method for co-production of hydrogen gas and biochar of claim 1, further comprises:
before performing the hydrogen production step and the heating step, performing a preheating step on the catalyst.

4. The manufacturing method for co-production of hydrogen gas and biochar of claim 3, wherein the catalyst comprises a cuprous oxide catalyst, and a preheating temperature in the preheating step is 250° C. to 300° C.

5. The manufacturing method for co-production of hydrogen gas and biochar of claim 3, wherein the catalyst comprises a platinum catalyst, and a preheating temperature in the preheating step is 150° C. to 200° C.

6. The manufacturing method for co-production of hydrogen gas and biochar of claim 1, wherein the molar ratio (S/C) of the water to the methanol liquid is 1 to 2.5.

7. The manufacturing method for co-production of hydrogen gas and biochar of claim 1, wherein the molar ratio (O₂/C) of the oxygen gas to the methanol liquid is 0.3 to 0.6, and the molar ratio (S/C) of the water to the methanol liquid is 0.

8. The manufacturing method for co-production of hydrogen gas and biochar of claim 1, wherein a gas hourly space velocity (GHSV) of the hydrogen production system is 5000 h⁻¹ to 10000 h⁻¹.

9. The manufacturing method for co-production of hydrogen gas and biochar of claim 1, wherein the hydrogen production system further comprises:
a first thermocouple thermometer disposed in the reactor and configured to measure a first temperature in the hydrogen production step; and
a second thermocouple thermometer disposed in the reactor and configured to measure a second temperature in the heating step.

10. The manufacturing method for co-production of hydrogen gas and biochar of claim 9, wherein the first temperature is 310° C. to 460° C.

11. The manufacturing method for co-production of hydrogen gas and biochar of claim 9, wherein the first temperature is 400° C. to 620° C.

12. The manufacturing method for co-production of hydrogen gas and biochar of claim 1, wherein a reaction time in the hydrogen production step is 15 minutes to 2 hours.

13. The manufacturing method for co-production of hydrogen gas and biochar of claim 1, wherein a methanol conversion of the hydrogen production system is at least 77%.

14. The manufacturing method for co-production of hydrogen gas and biochar of claim 1, wherein a hydrogen yield of the hydrogen production system is 1 to 2 mol·(mol CH₃OH)⁻¹.

15. The manufacturing method for co-production of hydrogen gas and biochar of claim 1, wherein a heating temperature in the heating step is 110° C. to 350° C., and a heating time in the heating step is 30 minutes to 2 hours.

16. The manufacturing method for co-production of hydrogen gas and biochar of claim 1, wherein a heating temperature in the heating step is 300° C. to 470° C., and a heating time in the heating step is 30 minutes to 2 hours.

17. The manufacturing method for co-production of hydrogen gas and biochar of claim 1, wherein after the heating step is performed for 5 minutes, a gas concentration of oxygen content in the hydrogen production system is less than 1%.

18. The manufacturing method for co-production of hydrogen gas and biochar of claim 1, wherein a contact angle of the biochar is 86° to 103°.

19. The manufacturing method for co-production of hydrogen gas and biochar of claim 1, wherein a higher heating value (HHV) of the biochar is 18 MJ/kg⁻¹ to 23 MJ/kg⁻¹, and a fixed carbon (FC) content of the biochar is 20% to 40%.

20. The manufacturing method for co-production of hydrogen gas and biochar of claim 1, wherein a higher heating value (HHV) of the biochar is 16 MJ/kg⁻¹ to 26 MJ/kg⁻¹, and a fixed carbon (FC) content of the biochar is 25% to 50%.
